(19) United States
(12) Patent Application Publication
(10) Pub. No.: US 2018/0203908 A1
(43) Pub. Date: Jul. 19, 2018

(54) DISTRIBUTED DATABASE SYSTEM AND DISTRIBUTED DATA PROCESSING METHOD

(71) Applicant: Kabushiki Kaisha Toshiba, Minato-ku (JP)

(72) Inventors: Taiga Katayama, Ota (JP); Mototaka Kanematsu, Yokohama (JP); Shigeo Hirose, Kawasaki (JP)

(73) Assignee: Kabushiki Kaisha Toshiba, Minato-ku (JP)

(21) Appl. No.: 15/864,141

(22) Filed: Jan. 8, 2018

(30) Foreign Application Priority Data
Jan. 16, 2017 (JP) 2017-005121

(51) Int. Cl. G06F 17/30

(52) U.S. Cl. CPC G06F 17/30545; G06F 17/30327; G06F 17/30283

(57) ABSTRACT

A database system is formed by connecting node devices in parent-child relations. Each of the node devices includes a data storing unit, a saving rule storing unit, a storage processing unit, and an inquiry processing unit. The saving rule storing unit stores a saving rule used for saving data stored in the data storing unit to a parent node device in a case in which its own node device is not a parent of a highest rank and deleting the data in a case in which its own node device is the parent of the highest rank. The storage processing unit writes data and saves data to be saved from the data storing unit into a parent node in an order represented by order information associated with the data or deletes data to be deleted by referring to the saving rule.

### BACKGROUND OF THE INVENTION

### Field of the Invention

Embodiments of the present invention relate to a database system and a data processing method.

### Description of Related Art

According to the wide use of IoT devices, data generated at various places under various situations is used through networks more frequently. In a conventional technology, data generated by IoT devices and the like is collected in a central server apparatus through a network and is stored in a database system of the central server apparatus. Massive data stored in a database system of a central server apparatus is searched and used by a user when necessary.

Meanwhile, in the conventional technology, the central server apparatus side needs to include a large capacity storage unit (for example, a magnetic hard disk device, a semiconductor memory, or the like) for storing a large amount of data, and there are cases in which the system incurs a high cost.

An IoT device and a device relaying the IoT device and a central server apparatus (a gateway device, a router, or the like) internally include a unit that stores data. However, in the conventional technology, when a system architecture in which data is centrally stored in the central server apparatus is employed, a storage unit of such a terminal device and an intermediate device are not used, and there is room for improvement.

In the conventional technology, since data is centrally stored in the central server apparatus, when collected data is searched (execution of a query), the load of the process is concentrated on the central server apparatus, and there is a possibility of lowered efficiency.

In a conventional technology, an architecture in which data is searched by using query processing engines arranged in a tree pattern in a hierarchical manner is also employed in some systems. However, even in such a system, data is centrally stored in a central server apparatus, and it is difficult to solve the above-described problem of load concentration.

In conventional distributed database systems, a form in which a method for distributed arrangement of a database is determined on the basis of the status of the distribution of data access for distributing the load is employed in some systems. However, a complicated process is necessary for the determination of distributed arrangement on the basis of access distribution, and there is a problem in that the management becomes complex.

### Patent Documents

[Patent Document 1] Japanese Unexamined Patent Application, First Publication No. H06-259478

### Non-Patent Documents

[Non-Patent Document 1] “Apache Drill,” [online], [accessed Nov. 11, 2016], Internet <URL:http://drill.apache.org/>

### SUMMARY OF THE INVENTION

An object to be achieved by the present invention is to provide a database system and a data processing method capable of efficiently storing data, distributing the load for a search process, and simply performing rearrangement of data on the basis of simple key information.

A database system according to an embodiment is formed by connecting a plurality of node devices in parent-child relations. Each of the node devices includes a data storing unit, a saving rule storing unit, a storage processing unit, and an inquiry processing unit. The data storing unit stores data. The saving rule storing unit stores a saving rule used for saving the data stored in the data storing unit to a parent node device in a case in which its own node device is not a parent of a highest rank and deleting the data stored in the data storing unit in a case in which its own node device is the parent of the highest rank. The storage processing unit receives a registration request for data, writes the registration request in the data storing unit, and saves data to be saved from the data storing unit in a parent node device in an order represented by order information associated with the data or deletes data to be deleted from the data storing unit by referring to the saving rule of the saving rule storing unit. The inquiry processing unit receives a search request for data, searches the data stored in the data storing unit of its own node device to acquire a first search result, transmits the search request to a child node device to acquire a second search result from the child node device, and transmits the first search result and the second search result to a request source.

### BRIEF DESCRIPTION OF THE DRAWINGS

FIG. 1 is a configuration diagram illustrating a schematic configuration of a database system according to a first embodiment;

FIG. 2 is a functional block diagram illustrating a schematic functional configuration of a node device according to the first embodiment;

FIG. 3 is a schematic diagram illustrating the basic structure of data stored by the database system according to the first embodiment;

FIG. 4A is a schematic diagram illustrating an example of the data configuration of a connection list stored by a connection list storing unit of a node device positioned in an intermediate layer according to the first embodiment;

FIG. 4B is a schematic diagram illustrating an example of the data configuration of a connection list stored by a connection list storing unit of a node device positioned in a root layer according to the first embodiment;

FIG. 4C is a schematic diagram illustrating an example of the data configuration of a connection list stored by a connection list storing unit of a node device positioned in a leaf layer according to the first embodiment;

FIG. 5A is a schematic diagram illustrating an example of the data configuration of storage information stored by a storage information storing unit according to the first embodiment and is a case in which only data of an own node storing range is included, and data of a child node storing range is not included;

FIG. 5B is a schematic diagram illustrating an example of the data configuration of storage information stored by the storage information storing unit according to the first embodiment and is a case in which data of an own node storing range and data of a child node storing range are included;

FIG. 6 is a flowchart illustrating the sequence of a data registering process in the node device according to the first embodiment;

FIG. 7 is a flowchart illustrating the sequence of a data searching process in the node device according to the first embodiment;

FIG. 8A is a flowchart illustrating the sequence of the data registering process of a case in which regular saving is selected as a saving rule in the node device according to the first embodiment;

FIG. 8B is a flowchart illustrating the sequence of a data saving process of a case in which regular saving is selected as a saving rule in the node device according to the first embodiment;

FIG. 9 is a flowchart illustrating the sequence of a data registering and saving process of a case in which sequential saving is selected as a saving rule based on the amount of added data in the node device according to the first embodiment;

FIG. 10 is a flowchart illustrating the sequence of a data registering and saving process of a case in which sequential saving based on insufficient capacity is selected as a saving rule in the node device according to the first embodiment;

FIG. 11A is a flowchart illustrating the sequence of a data registering process of a case in which sequential saving based on free space is selected as a saving rule in the node device according to the first embodiment;

FIG. 11B is a flowchart illustrating the sequence of a data saving process of a case in which sequential saving based on free space is selected as a saving rule in the node device according to the first embodiment;

FIG. 12 is a flowchart illustrating a detailed sequence of a data moving process in the node device according to the first embodiment;

FIG. 13 is a flowchart illustrating a detailed sequence of a data searching process in the node device according to the first embodiment;

FIG. 14 is a schematic diagram illustrating the basic structure of data stored by a database system according to a second embodiment;

FIG. 15 is a schematic diagram illustrating a status in which data having a plurality of series is stored in node devices having a tree structure in a distributed manner in the database system according to the second embodiment;

FIG. 16 is a schematic diagram illustrating an example of data storage of a case in which data distribution among nodes is performed using a common storage range for a plurality of series in the database system according to the second embodiment;

FIG. 17 is a schematic diagram illustrating an example of data storage of a case in which data distribution among nodes is performed using an independent storage range for each of a plurality of series in the database system according to the second embodiment;

FIG. 18 is a schematic diagram illustrating an example of a connection form of a node device group in a database system according to a third embodiment; and

FIG. 19 is a schematic diagram illustrating an example of a connection form of a node device group in a database system according to a fourth embodiment.

### DETAILED DESCRIPTION OF THE INVENTION

Hereinafter, database systems and data processing methods according to embodiments will be described with reference to the drawings.

### First Embodiment

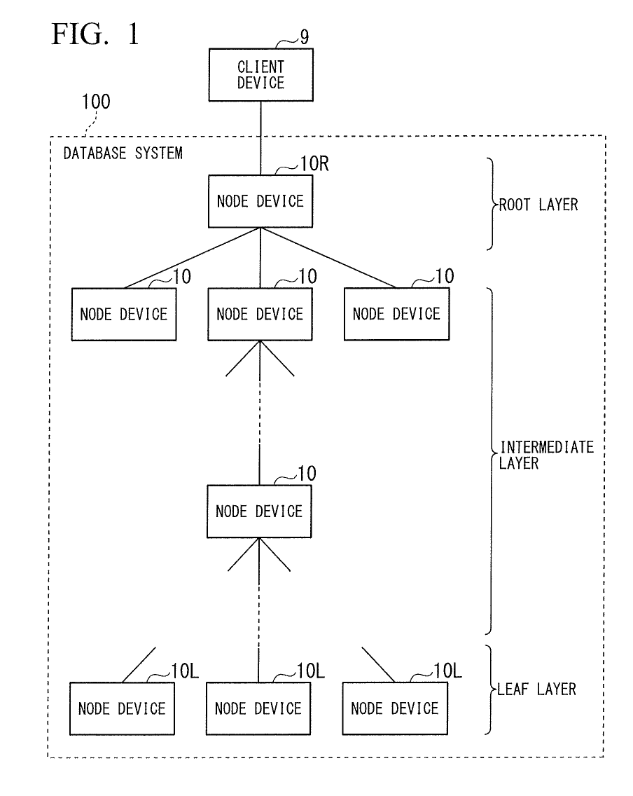

FIG. 1 is a configuration diagram illustrating a schematic configuration of a database system according to this embodiment. As illustrated in the drawing, the database system 100 is configured to include a plurality of node devices 10 arranged in a hierarchical structure. In other words, the database system 100 is formed by connecting a plurality of node devices in a parent-child relation having a hierarchical structure. Such node devices 10 are arranged in a tree structure pattern. In other words, each node device 10 is connected to no parent node or one parent node and is connected to no child node or one or more child nodes. In the drawing, a node device 10 arranged on the upper side is in a parent direction, and a node device 10 arranged on the lower side is in a child direction. In such a hierarchical structure of the node devices 10, particularly, a node device of the highest rank having no parent is a root node device. A reference numeral 10R is assigned to the root node device. In the hierarchical structure, particularly, a node device having a lowest rank having no child is a leaf node device. A reference numeral 10L is assigned to the leaf node device. A node device 10 that is neither a root node device 10R nor a leaf node device 10L is a node device that belongs to an intermediate layer.

A depth (the number of stages of connection) from the root node device 10R to the leaf node device 10L may be the same in all the branches or may be different in each branch.

An example of the actual device configuration for building the database system 100 is as follows. A leaf node device 10L positioned at an end of the tree structure is, for example, a certain IoT device. “IoT” is an abbreviation for “Internet of Things.” Data that is accumulated and managed by the database system 100 is generated and collected by the node devices 10L. The root node device 10R positioned at the root is, for example, a central server apparatus. The node device 10R receives an inquiry relating to the data managed by the database system 100 from a client device 9 for the first time and returns a result of the inquiry to the client device 9. A node device 10 positioned in an intermediate layer that is neither the root layer nor the leaf layer is, for example, a gateway device having a role of relaying data. More specifically, the gateway device is a computer, a communication device (a router or the like), or the like. The gateway device, for example, connects an IoT device and a central server apparatus.

While a central server apparatus, other computers, a router, and an IoT device have been illustrated as specific examples of the node device 10, devices that can function as the node devices 10 according to this embodiment are not limited thereto.

An application program can operate on the client device 9. An application program operating on the client device 9 issues an inquiry used for requesting data for the database system 100. This inquiry may accompany a search condition of data. In a case in which an inquiry received from the client device 9 includes a search condition, the database system returns data matching the condition to the client device 9.

The database system 100 stores data in the node devices 10 (including the node devices 10L and the node device 10R) in a distributed manner. In other words, data generated by the node device 10L is accumulated first in a storage unit included in the node device 10L. Before the storage unit of the node device 10L overflows with data, the data is saved in the direction of an upper hierarchy (a direction toward the root node 10R). Similarly, the node device 10 positioned in the intermediate layer saves data. In other words, the node device 10 positioned in the intermediate layer saves data saved from the node device 10 of a lower rank and saves data in the direction of the upper hierarchy (the direction toward the root node 10R) before a storage unit inside the device overflows with the data.

The root node device 10R accumulates data saved from a node device 10 of a lower rank. However, the root node device 10R is not connected to a node device 10 of a higher rank and thus, deletes unnecessary data before a storage unit of the root node device 10R overflows with data. Alternatively, instead of simply deleting unnecessary data, the root node device 10R may record data on an archive recording medium (for example, a magnetic tape, a magneto-optical disc device, or the like).

Next, the internal functional configuration of each node device 10 will be described.

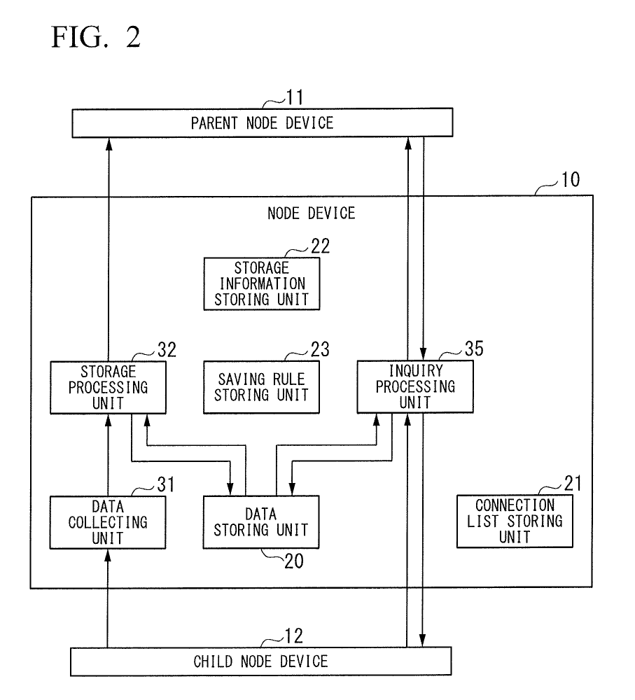

FIG. 2 is a block diagram illustrating a schematic functional configuration of the node device 10 (including the node device 10R and the node device 10L). As illustrated in the drawing, the node device 10 is configured to include a data storing unit 20, a connection list storing unit 21, a storage information storing unit 22, a saving rule storing unit 23, a data collecting unit 31, a storage processing unit 32, and an inquiry processing unit 35. Each unit configuring the node device 10 is realized by using an electronic circuit. Each unit, includes a storage unit used for storing information according to necessity. The node device 10 may be realized by using a computer and a program.

In the case of a node positioned in the intermediate layer or the leaf layer, the node device 10 is connected to a parent node device 11. On the other hand, in the case of a node positioned in the root layer or the intermediate layer, the node device 10 is connected to a child node device 12. In other words, in the case of a node positioned in the intermediate layer, the node device 10 is connected to both the parent node device 11 and the child node device 12.

Parent and child are relative concepts. A certain node device 10 may be a child of another node device 11, and at the same time, the node device 10 may be a parent of yet another node device 12.

The data storing unit 20 stores data to be stored by its own node device 10. The data storing unit 20 is realized, for example, by a recording medium such as a magnetic hard disk device or a semiconductor memory. The configuration of the data stored by the data storing unit 20 will be described later with reference to another diagram.

The connection list storing unit 21 stores information of connections with other node devices 10. As one form, the connection list storing unit 21 stores a list of information of a parent node device 11 and a child node device 12 that are directly connected to its own node device 10. As another form, the connection list storing unit 21 may store a list of information of all the node devices 10 included in the whole tree structure. The connection list storing unit 21 stores information of addresses (IP addresses or the like), logical names of nodes, and connection relations (that a certain node is a parent or a child of a node) as the information of other node devices 10.

When the data collecting unit 31, the storage processing unit 32, and the inquiry processing unit 35 are connected to and communicate with a parent or child node device, this connection list storing unit 21 is referred to.

The storage information storing unit 22 stores information of the range of data stored by its own node device 10.

In other words, the storage information storing unit 22 stores information of the range of order information associated with data stored in the data storing unit 20 of its own node device 10. This information of the range of data may be represented as information of a range (an upper limit and a lower limit) of information representing order of data. In this embodiment, the information representing the order of data is information of time. The information of time is, for example, information of a numerical value representing Hours:Minutes:Seconds (may further include a unit smaller than seconds). The information of time may include information of a date such as the year, month, and date. In other words, the storage information storing unit 22 stores information of the upper limit and the lower limit of time as the information of the range of data stored by its own node device 10.

The storage information storing unit 22 stores the information (this will be conveniently referred to as descendant node storage information) of the range of data included in a child node device 12 or a node device of a further descendant thereof (in the direction of the leaf side). A part of the storage information storing unit 22 that stores the descendant node storage information will be referred to as a descendant node storage information storing unit. The information representing the range of data stored by the child node device 12 is at least time information (a lower limit of a time value in the range) of oldest data included in the child node device 12 or a node device of a further descendant node.

A specific example of data stored by the storage information storing unit 22 will be described later with reference to a drawing.

The saving rule storing unit 23 stores a rule (a method or a policy) for selecting data to be saved in the parent node device 11 among data stored by its own node device 10. However, in a case in which there is no parent node device 11, instead of saving the data, the data is deleted only.

Here, an example of the saving rule for the tree structure of the database system 100 will be described. As examples of the saving rule, there are at least four types of (A) Regular saving, (B) Sequential saving based on the amount of added data, (C) Sequential saving based on the amount of insufficient capacity, and (D) Sequential saving based on free space. The saving rule storing unit 23 stores data used for identifying the type of rule to be used.

In other words, the saving rule storing unit 23 stores a saving rule for saving data stored in the data storing unit 20 in a parent node device in a case in which its own node device is not a parent of the highest rank. The saving rule described above stored by the saving rule storing unit 23 is applied as a rule for deleting data stored in the data storing unit 20 in a case in which its own node device is a parent of the highest rank

Details of the four types of rules described above will be described next.

### (A) Regular Saving

In the regular saving, data of a predetermined amount set in advance is saved by its own node device 10 in the parent node device 11 even time when a predetermined time interval set in advance elapses. As a modified example of the regular saving, the predetermined time interval described above may be changed according to a period of time, day, date, or the like. The amount of data to be saved may be changed according to a period of time, day, date, or the like.

In other words, in such a case, the saving rule storing unit 23 stores a saving rule (regular saving rule) used for saving a predetermined amount of data stored in the data storing unit 20 to a parent node device at a predetermined time interval in a case in which its own node device is not a parent of a highest rank and deleting a predetermined amount of the data at a predetermined time interval in a case in which its own node device is a parent of the highest rank.

### (B) Sequential Saving Based on Amount of Added Data

In the sequential saving on the basis of the amount of added data, when data collected by the data collecting unit 31 is added to its own node, the amount of the added data is calculated, and data is saved such that free space for storing the added data is secured inside the data storing unit 20 of its own node. In other words, old data of an amount that is necessary for securing free space is saved from its own node device 10 into the parent node device 11. The capacity of the data storing unit 20 used for the calculation at this time may be capacity that is physically included in the storage device or capacity that is set using a parameter or the like.

In this case, the saving rule storing unit 23 stores a saving rule (the sequential saving rule based on the amount of added data) used for calculating the amount of data to be written when data is written into the data storing unit 20 of its own node device, and, when the free space of the data storing unit 20 is insufficient, saving data that is necessary for securing free space among data stored in the data storing unit 20 into a parent node device in a case in which its own node device is not a parent of the highest rank and deleting data that is necessary for securing free space among the data in a case in which its own node device is a parent of the highest rank.

### (C) Sequential Saving Based on Insufficient Capacity

In the sequential saving on the basis of insufficient capacity, data collected by the data collecting unit 31 is attempted to be written (added) into the data storing unit 20 of its own node and, in a case in which the capacity of the data storing unit 20 is insufficient, a predetermined data is saved. In other words, the data of the predetermined amount is saved from its own node device 10 into the parent node device 11. Until all the data to be added at that time can be written into the data storing unit 20 of its own node, the saving of the predetermined amount of data into the parent node is repeated. Also at this time, the capacity of the data storing unit 20 may be capacity that is physically stored by the storage device or capacity set using a parameter or the like.

In this case, the saving rule storing unit 23 stores a saving rule (the rule of the sequential saving on the basis of insufficient capacity) used for, when a capacity insufficiency error occurs as a result of the attempt to write data into the data storing unit 20 of its own node device, saving the data stored in the data storing unit 20 into a parent node device in a case in which its own node device is not a parent of the highest rank and deleting data in a case in which its own node device is a parent of the highest rank.

### (D) Sequential Saving Based on Free Space

In the sequential saving on the basis of free space, free space of the data storing unit 20 of its own node is monitored, and, when the free space is below a threshold set in advance, data of a predetermined amount is saved into the parent node device 11. Alternatively, in a case in which the size of one piece of data is a fixed length, instead of free space, the number of data vacancies (a numerical value representing the remaining number of pieces of data that can be stored) is monitored, and, in a case in which the vacancy number is below a threshold set in advance, a predetermined amount of data is saved into the parent node device 11. Also at this time, the capacity of the data storing unit 20 may be capacity that is physically included in the storage device or capacity set using a parameter or the like.

In such a case, the saving rule storing unit 23 monitors free space of the data storing unit 20 of its own node device. Then, when the free space is below a predetermined threshold, the saving rule storing unit 23 saves data stored in the data storing unit 20 into a parent node device in a case in which its own node device is not a parent of the highest rank and stores a saving rule (the sequential saving rule based on free space) for deleting data in a case in which its own node device is the parent of the highest rank.

As above, while four types of rules have been described, data may be saved from a child node into a parent node on the basis of other rules.

Also in a case in which any one of the rules is used, the root node device 10R only deletes data of a necessary amount from the data storing unit 20 instead of saving data. In other words, data is sequentially deleted from the database system 100 from the oldest data.

Except for a case under a special condition, generally, the storage range of data may be different between mutually-different node devices belonging to the same hierarchy. In other words, there are cases where the storage range of data is different among a plurality of child node devices connected to a certain node device. Between a certain node device and the child node device thereof, there may be cases where the storage ranges of data overlap each other in a part.

The “under a special condition” described above is, for example, a case in which the (A) regular saving is used, a time interval for performing the regular saving is the same for all the nodes, the depth (the number of stages of a connection) from the root node device 10R to a leaf node device 10L is constant without being dependent on a branch of the tree, the data generation frequency (the amount of data per unit time) is the same for all the leaf node devices 10L, and the amount of saved data per one time in each node device of a certain hierarchy level is the same. In only a case in which such a special condition is satisfied, the storage range (the upper limit time and the lower limit time) of data at that time point is determined for each hierarchy level.

The data collecting unit 31 collects data to be stored in its own node device 10. In a case in which its own node device 10 is a node positioned in the root layer or an intermediate layer, the data collecting unit 31 collects data from the child node device 12. In a case in which own node device 10 is a node positioned in a leaf layer, the data collecting unit 31, for example, collects data generated by its own node device 10 or collects data generated by a sensor or the like connected thereto.

In any one of the cases, the data collecting unit 31 delivers the collected data to the storage processing unit 32.

The storage processing unit 32 writes the data delivered from the data collecting unit 31 into the data storing unit 20 of its own node device 10. The storage processing unit 32 reads data to be saved from the data storing unit 20 of its own node device 10 in accordance with the saving rule acquired by referring to the saving rule storing unit 23 and transmits the read data to the parent node device 11. When data is saved, the storage processing unit 32 deletes the data that is the saving target from the data storing unit 20.

However, in a case in which its own node device 10 is a node positioned in the root layer, a parent node device 11 is not present, and thus, the transmission of data to be saved to the parent node device 11 is not performed.

In a case in which data received from the data collecting unit 31 is written in the data storing unit 20 or a case in which data stored by the data storing unit 20 is saved, the storage processing unit 32 updates the storage information storing unit 22 as is appropriate. In other words, by updating the information of the range of data stored in the storage information storing unit 22, the storage processing unit 32 matches the range of data stored in the data storing unit 20 at that time point and the information of the range of data stored in the storage information storing unit 22 with each other.

In other words, by receiving a request for registering data and stores the data in the data storing unit 20 and referring to the saving rule stored by the saving rule storing unit 23, the storage processing unit 32 saves data to be saved from the data storing unit 20 into a parent node device in an order represented by the order information (information of time) associated with the data described above, or, in the root node, the storage processing unit 32 deletes data to be detected from the data storing unit 20 in an order represented by the order information (information of time) associated with the data described above. At this time, the storage processing unit 32, for example, by referring to the connection list storing unit 21, can acquire whether its own node device is a root node.

The inquiry processing unit 35 processes a search request received from a higher rank. More specifically, in a case in which own node device 10 is positioned in the root layer, the inquiry processing unit 35 processes a search request received from the client device 9. On the other hand, in a case in which its own node device 10 is positioned in an intermediate layer or a leaf layer, the inquiry processing unit 35 processes a search request received from the parent node device 11.

More specifically, the inquiry processing unit 35 performs (1) Search of the database of its own node device 10 (2) Distribution of a search request for the child node device 12, and (3) Determination of Whether a search request is stopped in its own node device 10 in accordance with a search range.

(1) Search of the database of its own node device is performed as below. By referring to the storage information storing unit 22, in a case in which there is a possibility that target data is stored by the data storing unit 20 of its own node device, the inquiry processing unit 35 searches data stored in the data storing unit 20.

(2) Distribution of a search request for a child node device is performed as below. By referring to the storage information storing unit 22, in a case in which there is a possibility that target data is stored by a child node device 12, the inquiry processing unit 35 distributes (transmits) the search request to such a child node device 12. At this time, the inquiry processing unit 35 acquires the information of the child node device 12 to be a distribution destination by referring to the connection list storing unit 21 as is necessary.

(3) Determination of Stop of a search request is performed as below. By referring to the storage information storing unit 22, in a case in which there is not a possibility that target data is stored by a child node device 12 at all, the inquiry processing unit 35 stops the search in its own node device 10 without distributing the search request for the child node device 12. The distribution of the search request for the child node device 12 is not performed, for example, in a case in which only data newer than predetermined time is stored in the child node device 12 and a node device of a further descendant (grandchild or the like), and a target of the search request is only data older than the predetermined time.

In other words, the inquiry processing unit 35 extracts a search condition relating to the order information included in a received search request and, in a case in which data matching the search condition is not stored in the data storing unit 20 of its own node device, does not search the data stored in the data storing unit 20 of its own node device and assumes the acquisition of data of an empty set as a result of the first search.

The inquiry processing unit 35 extracts a search condition relating to the order information included in a received search request and, in a case in which data matching the search condition is not stored in the data storing unit 20 of a child node device or a node device of a lower rank (in other words, a node device group of descendants), does not transmit the search request to the child node devices of the series and assumes the acquisition of data of an empty set as a result of the second search for the child node device.

The inquiry processing unit 35 integrates a result acquired through the search of the database of its own node device 10 and a search result returned from the child node device 12 and returns an integrated search result to the parent node device 11.

As described above, the inquiry processing unit 35 receives a data search request, searches data stored in the data storing unit 20 of its own node device, acquires a search result (this will be conveniently referred to as a first search result), transmits the search request to a child node device, acquires a search result (this will be conveniently referred to as a second search result) from the child node device, integrates the first search result and the second search result, and transmits the integrated search result to a request source. In a case in which a search of the data of the data storing unit 20 of its own node device is not performed, data of an empty set is regarded as the first search result. In a case in which a search request is not transmitted to the child node device, data of an empty set is regarded as the second search result.

Next, the structure of data stored by the database system 100 will be described.

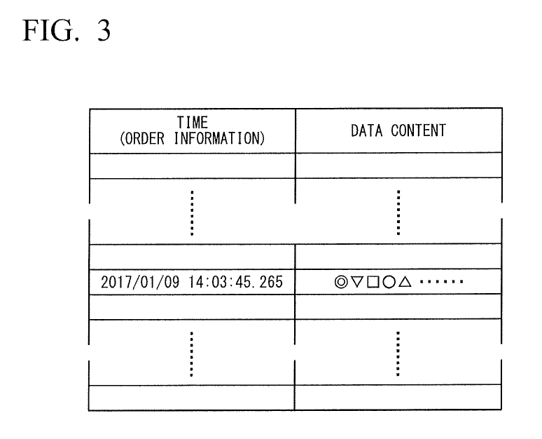

FIG. 3 is a schematic diagram illustrating the basic structure of data stored by the database system 100. The data storing unit 20 of each node device 10 stores data having the structure illustrated in the drawing. As an example, data is represented in a table form in the drawing. As illustrated in the drawing, the database system 100 stores and manages time (order information) and a data content in association with each other.

The time is time that is associated with a data content. As an example, the time is time when the data is generated. The time is represented in the form of “YYYY/NIM/DD hh:mm:ss.nnn” (year/month/date, hour:minute:second:1/1000 second). In the database system 100, data is uniquely ordered according to associated time. The data content is arbitrary data. As an example, the data content is generated by the node device 10L of a leaf layer.

Next, a connection list and storage information used by the database system 100 will be described.

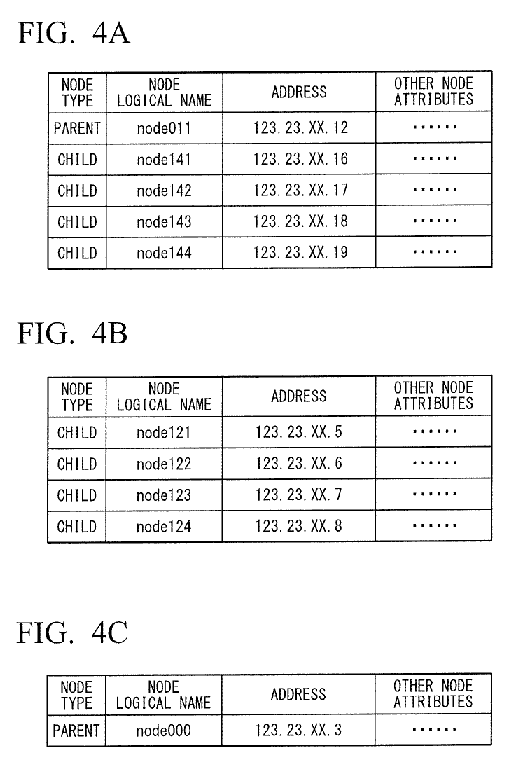

FIGS. 4A, 4B, and 4C are schematic diagrams illustrating examples of the data configuration of the connection list stored by the connection list storing unit 21. As illustrated in the drawing, the data of the connection list is represented in the form of a table as an example. The data of the connection list includes items of a node type, a node logical name, an address, and other node attributes.

The node type is data representing whether a node of a connection destination is a parent node or a child node when viewed from its own node. Since nodes are connected in a tree pattern, a node that is directly connected to its own node is either a parent node or a child node.

The node logical name is a logical name assigned for identifying a node that is a connection destination. The node logical name is a name that is unique for each node.

The address is information of an address used for communicating with a node that is a connection destination. As the address, for example, an IP address is used.

The other node attributes are information representing the attributes of the node, which is a connection destination, other than the node type, the node logical name, and the address.

FIG. 4A illustrates an example of a connection list stored by the node device 10 positioned in the intermediate layer. The connection list of the node device positioned in the intermediate layer includes information of one parent node and information of one or a plurality of child nodes.

FIG. 4B illustrates an example of the connection list stored by the node device 10 positioned in the root layer.

The connection list of the node device positioned in the root layer does not include information of a parent node but include information of one or a plurality of child nodes.

FIG. 4C illustrates an example of the connection list stored by the node device 10 positioned in the leaf layer.

The connection list of the node device positioned in the leaf layer includes information of one parent node but does not include information of a child node.

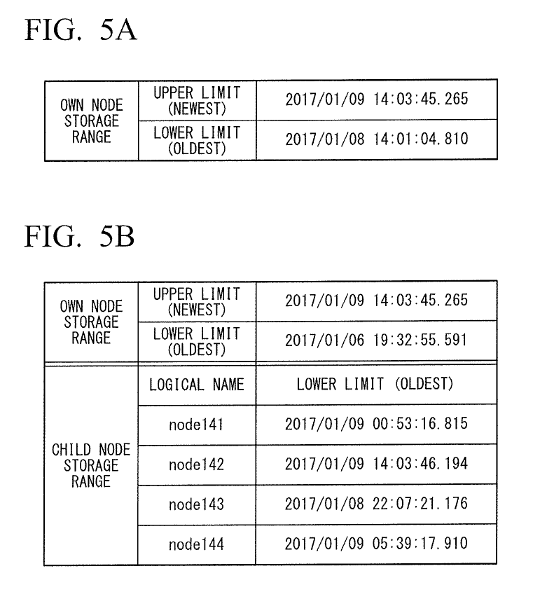

FIGS. 5A and 5B are schematic diagrams illustrating examples of the data configuration of storage information stored by the storage information storing unit 22.

FIGS. 5A and 5B illustrate storage information of different types.

The storage information illustrated in FIG. 5A includes only data of an own node storage range and does not include data of a child node storage range. In a case in which the storage range of the child node is determined when the storage range (range of time) of data of its own node is determined, the storage information storing unit 22 stores storage information of a type illustrated in FIG. 5A.

Its own node storage range is represented using the upper limit value and the lower limit value of the date and time data thereof. Here, the past side (a smaller numerical value side of the date and time) of the date and time is on the lower side, and the future side (a larger numerical value side of the date and time) is on the upper side. The upper limit value of its own node storage range is the value of time (date and time) associated with latest data among data stored by its own node device 10. The lower limit value of its own node storage range is the value of time (date and time) associated with oldest data among data stored by its own node device 10.

At this time, all the child node devices and node devices of further descendants thereof connected from its own node device store data associated with larger (newer) time than the upper limit value of its own node device storage range.

As the storage information storing unit 22 stores storage information of the type illustrated in FIG. 5A, the range of data stored in the node device 10 can be known.

The storage information illustrated in FIG. 5B includes data of an own node storage range and data of a child node storage range. Regardless of whether or not the storage range of a child node is determined when the storage range (range of time) of data of its own node is determined, the storage information storing unit 22 can store storage information of a type illustrated in FIG. 5B.

The data of its own node storage range is as described above.

The data of the child node storage range, for each direct child node of its own node, includes information of date and time associated with oldest data included in a branch (a branch including child nodes, grandchild nodes, and the like) including the child node. In other words, the data of the child node storage range, for each child node, includes a lower limit value of date and time associated with data included in the branch. Such a lower limit value of the date and time is stored in association with the logical name of a corresponding child node.

As the storage information storing unit 22 stores storage information of the type illustrated in FIG. 5B, the range of data stored in its own node device and the child node device and subsequent node devices can be known.

Next, the sequence of the process performed by each node device configuring the database system 100 will be described.

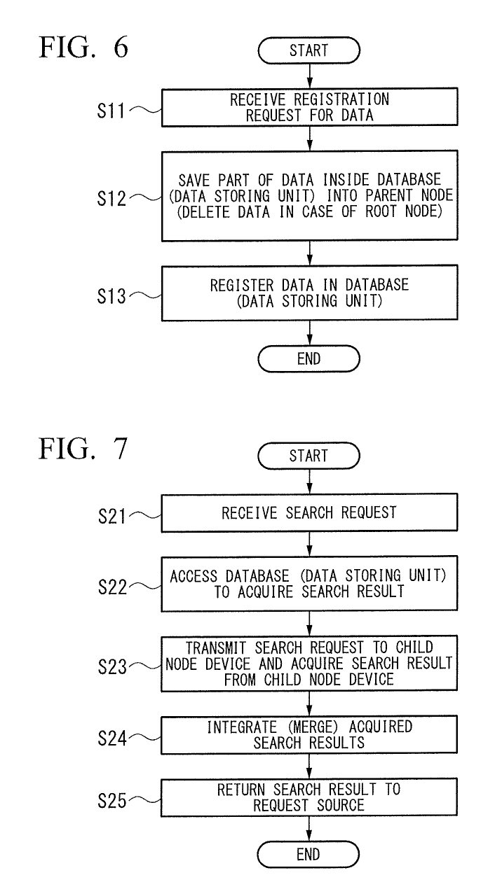

FIG. 6 is a flowchart illustrating the sequence of a data registering process in the node device 10 (including also the root node and the leaf nodes). Hereinafter, the description will be presented along this flowchart.

First, in Step S11, the storage processing unit 32 receives a registration request for data. In the node device 10 positioned in the root layer or the intermediate layer, the data registration request is transmitted from the child node device 12 and is received by the data collecting unit 31. In the node device 10 positioned in the leaf layer, the data registration request is based on data generation in the data collecting unit 31.

Next, in Step S12, the storage processing unit 32, as is necessary, saves a part of data included in the database (data storing unit 20) of its own node into a parent node. In other words, the storage processing unit 32 requests registration of saved data for the parent node device 11. Here, whether or not data to be actually saved is present depends also on a rule set by the saving rule storing unit 23, the status of free space of the data storing unit 20 at that time, and the like.

In the node device 10 positioned in the root layer, by performing the process of this step, instead of saving data into a parent node, the data is deleted only.

Next, in Step S13, the storage processing unit 32 registers the data in the database (the data storing unit 20) of its own node.

As above, the whole process of the flowchart ends. A detailed process of the data saving and storing will be described later in detail with reference to another flowchart.

FIG. 7 is a flowchart illustrating the sequence of a data searching process in the node device 10 (including also the root node and the leaf nodes). Hereinafter, the description will be presented along this flowchart.

First, in Step S21, the inquiry processing unit 35 receives a search request from the outside. In the node device 10 positioned in the root layer, this search request is transmitted from the client device 9. In the node device 10 positioned in the intermediate layer or the leaf layer, this search request is transmitted from a parent node device 11.

Next, in Step S22, the inquiry processing unit 35, accesses the database (data storing unit 20) of its own node on the basis of the search request received in Step S21 and acquires a search result. As will be described later, there are cases where the search of the database of its own node is omitted according to a condition (a condition of time) included in the search request.

Next, in Step S23, the inquiry processing unit 35 transmits a search request to a child node device 12 on the basis of the search request received in Step S21. A search result is acquired as a response from the child node device 12. In a case in which a plurality of child node devices 12 are connected, the inquiry processing unit 35 transmits a search request to each of such child node devices 12 and acquires search results. As will be described later, there are cases where a search request for a child node device 12 is omitted according to a condition (a condition of time) included in the search request.

Next, in Step S24, the inquiry processing unit 35 integrates (merges) the search result acquired from the database of its own node and the search result acquired from the child node device 12. Any one of the search of the database of its own node and the search of the child node device is omitted, when the integration is performed, the search result of the omitted side is regarded as being an empty set.

Next, in Step S25, the inquiry processing unit 35 returns a search result acquired in Step S24 to a request source.

As above, the whole process of this flowchart ends. A detailed process of the data search will be described later in detail with reference to another flowchart.

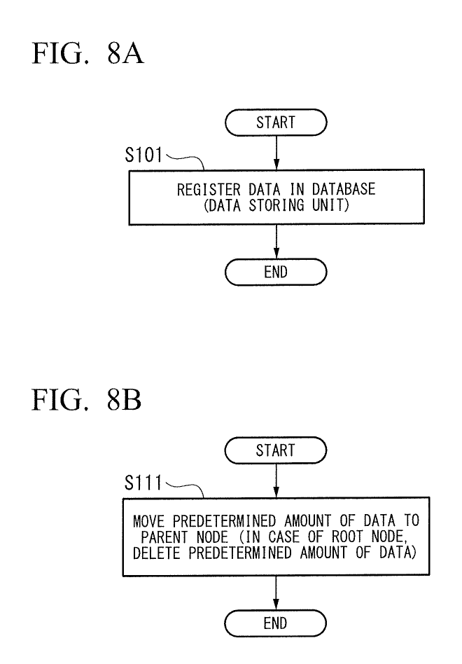

FIGS. 8A, 8B, 9, 10, 11A, and 11B are flowcharts illustrating the sequences of data saving and data registering processes according to each saving rule. Hereinafter, the process of each case of (A) Regular saving, (B) Sequential saving based on the amount of added data, (C) Sequential saving based on insufficient capacity, and (D) Sequential saving based on free space will be described.

FIGS. 8A and 8B are flowcharts illustrating the sequences of the data registering and saving processes of a case in which the regular saving is selected as a saving rule. FIG. 8A illustrates the sequence of the data registering process, and FIG. 8B illustrates the sequence of the data moving process. The data storing process and the data moving process can be performed independently as separate threads in parallel with each other in the node device 10. The data moving process is repeated performed at a predetermined time interval.

In Step S101 illustrated in FIG. 8A, the storage processing unit 32 registers data delivered from the data collecting unit 31 in the database (the data storing unit 20) of its own node. When the process of this step ends, the whole process of this flowchart ends.

In Step S111 illustrated in FIG. 8B, the storage processing unit 32 moves a predetermined amount of data to the parent node device 11. In other words, the storage processing unit 32 requests registration of the data for the parent node device 11. In a case in which data present in the data storing unit 20 does not reach the predetermined amount described above, all the present data is moved to the parent node device 11. However, in a case in which its own node device 10 is positioned in the root layer, the storage processing unit 32 only deletes the data instead of moving the predetermined amount of data to the parent node. When the process of this step ends, the whole process of this flowchart ends.

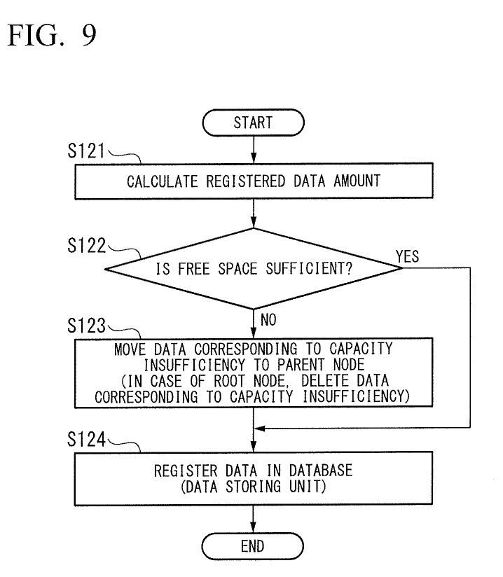

FIG. 9 is a flowchart illustrating the sequences of the data registering and saving processes of a case in which the sequential saving based on the amount of added data is selected as a saving rule. Hereinafter, the description will be presented along this flowchart.

First, in Step S121, the storage processing unit 32 calculates the amount of data to be registered.

Next, in Step S122, the storage processing unit 32 determines whether or not a sufficient free space is present in the database (the data storing unit 20) on the basis of the amount of data to be registered calculated in Step S121. In a case in which the free space is sufficient (Yes in Step S122), the process proceeds to Step S124. On the other hand, in a case in which the free space is insufficient (No in Step S122), the process proceeds to the next Step S123.

In a case in which the process proceeds to the next Step S123, the storage processing unit 32 moves data corresponding to the insufficient capacity to the parent node device 11 in Step S123. In a case in which its own node device 10 is a node positioned in the root layer, instead of moving the data to the parent node, the data is only deleted from the database (the data storing unit 20).

Next, in Step S124, the storage processing unit 32 registers the data delivered from the data collecting unit 31 in the database (the data storing unit 20) of its own node. When the process of this step ends, the whole process of this flowchart ends.

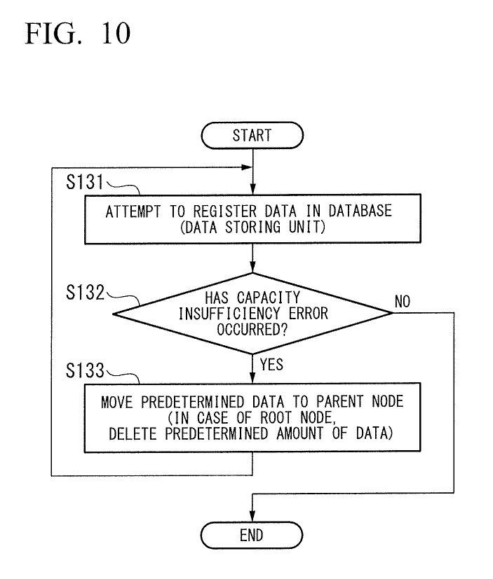

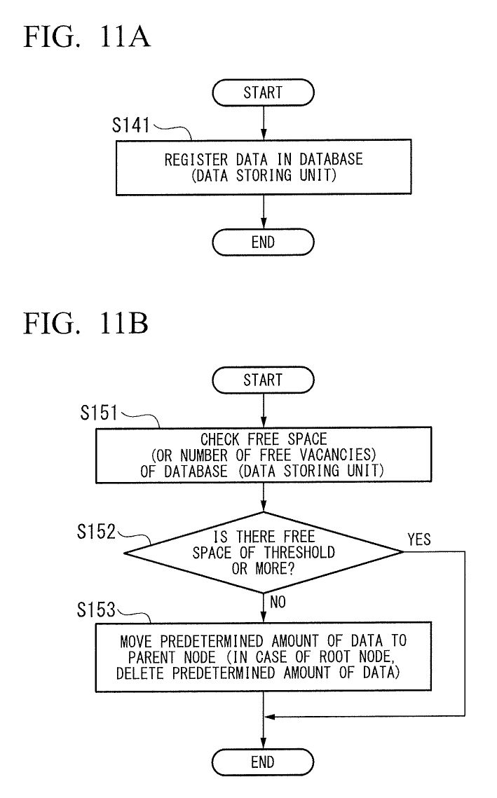

FIG. 10 is a flowchart illustrating the sequences of the data registering and saving processes of a case in which the sequential saving based on insufficient capacity is selected as a saving rule. Hereinafter, the description will be presented along this flowchart.

First, in Step S131, the storage processing unit 32 attempts to register data delivered from the data collecting unit 31 in the database (the data storing unit 20) of its own node.

Next, in Step S132, the storage processing unit 32 determines whether or not a capacity insufficiency error has occurred in the registration (writing) of data in Step S131. In a case in which the capacity insufficiency error has occurred (Yes in Step S132), the process proceeds to Step S133. On the other hand, in a case in which the registration of the data has been normally completed without a capacity insufficiency error occurring (No in Step S132), the whole process of this flowchart ends.

Next, in a case in which the process proceeds to Step S133, the storage processing unit 32 moves a predetermined amount of data to the parent node device 11 in Step S133. However, in a case in which its own node device 10 is a node positioned in the root layer, in this step, instead of moving a predetermined amount of data to the parent node device 11, the data is only deleted from the database (the data storing unit 20).

When the process of this step ends, the process is returned to Step S131 again.

FIGS. 11A and 11B are flowcharts illustrating the sequences of the data registering and saving processes of a case in which the sequential saving based on free space is selected as a saving rule. FIG. 11A illustrates the sequence of the data registering process, and FIG. 11B illustrates the sequence of the data moving process. In an order to move data, the storage processing unit 32 monitors free space of the database. The data storing process and the data moving process can be performed independently as separate threads in parallel with each other in the node device 10. The data moving process is repeatedly performed at a predetermined time interval.

In Step S141 illustrated in FIG. 11A, the storage processing unit 32 registers data delivered from the data collecting unit 31 in the database (the data storing unit 20) of its own node. When the process of this step ends, the whole process of this flowchart ends.

In Step S151 illustrated in FIG. 11B, the storage processing unit 32 checks free space or the number of vacancies of the database (the data storing unit 20) of its own node. Here, a case in which the number of vacancies can be checked is in a case in which the size of one piece of data is a fixed length or the like.

Next, in Step S152, the storage processing unit 32 determines whether or not the free space or the like checked in Step S151 is a threshold set in advance or more. In a case in which the free space that is the threshold or more is present (Yes in Step S152), the whole process of this flowchart ends. On the other hand, in a case in which the free space is less than the threshold (No in Step S152), the process proceeds to the next Step S153.

Next, in a case in which the process proceeds to Step S153, the storage processing unit 32 moves a predetermined amount of data to the parent node device 11 in Step S153. However, in a case in which its own node device 10 is a node positioned in the root layer, in this step, instead of moving the predetermined amount of data to the parent node device 11, the data is only deleted from the database (the data storing unit 20) in this step. When the process of this step ends, the whole process of this flowchart ends.

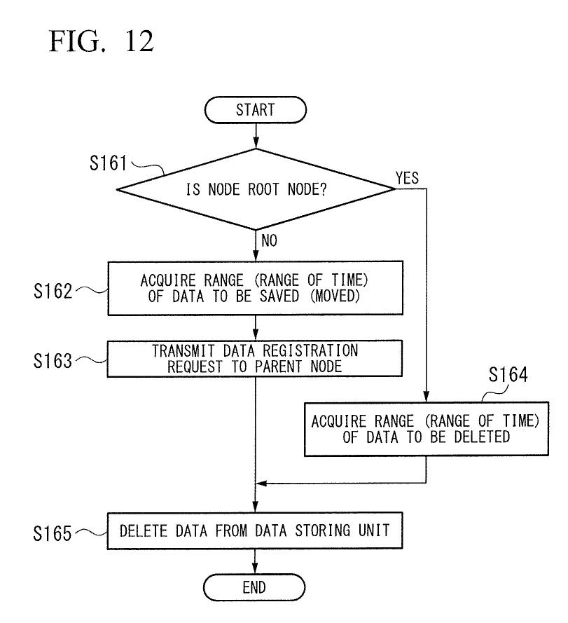

FIG. 12 is a flowchart illustrating a more detailed sequence of the data moving process.

In other words, FIG. 12 illustrates a detailed sequence of the data moving (saving) process performed in Step S111 illustrated in FIG. 8B, Step S123 illustrated in FIG. 9, Step S133 illustrated in FIG. 10, or Step S153 illustrated in FIG. 11B. Hereinafter, the description will be presented along this flowchart.

First, in Step S161, the storage processing unit 32 determines whether or not its own node is a root node. It can be determined whether or not its own node is a root node, for example, by referring to the connection list storing unit 21 or referring to other definition information. In a case in which its own node is a root node (Yes in Step S161), the process proceeds to Step S164. On the other hand, in a case in which its own node is not a root node (No in Step S161), the process proceeds to Step S162.

Next, in a case in which the process proceeds to Step S162, the storage processing unit 32 acquires information of the range of data to be moved in Step S162. In other words, the storage processing unit 32 acquires information of the range of time associated with the data to be moved. The data is moved to the parent node in an order from the oldest data. Thus, information of a desirable range can be acquired from the amount of data to be moved and data stored in the database (the data storing unit 20) at that time point.

Next, in Step S163, the storage processing unit 32 transmits a data registration request for the range of data for the parent node device 11. When the process of this step ends, next, the process proceeds to Step S165.

On the other hand, in a case in which the process proceeds to Step S164, the storage processing unit 32 acquires information of a range of data to be deleted in Step S164. In other words, the storage processing unit 32 acquires information of a range of time associated with the data to be deleted. A principle used for acquiring the information of the range is similar to that described in Step S162.

Next, in Step S165, the storage processing unit 32 deletes data (or data that is a deletion target in the case of a root node) that is a moving target from the database (the data storing unit 20).

As above, the whole process of this flowchart ends.

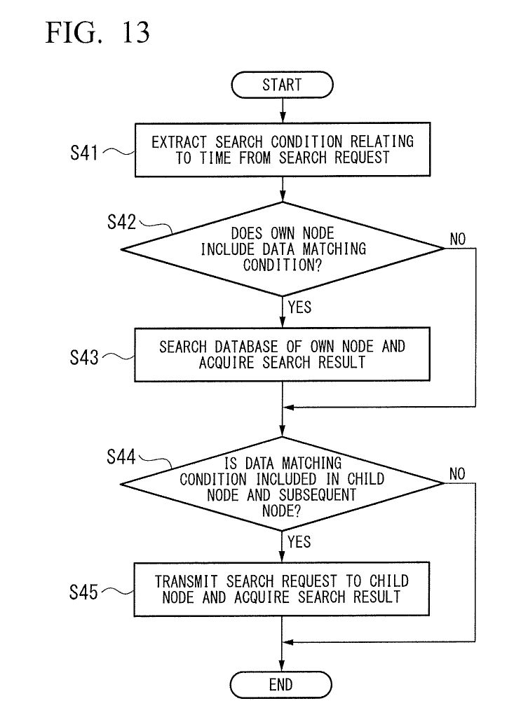

FIG. 13 is a flowchart illustrating a further detailed processing sequence of the data search. The process illustrated in the drawing is a part corresponding to the process of Steps S22 and S23 illustrated in FIG. 7. As illustrated in the drawing, the inquiry processing unit 35 distributes and processes a search request. Hereinafter, the description will be presented along this flowchart.

First, in Step S41, the inquiry processing unit 35 extracts a search condition relating to time from a received search request.

Next, in Step S42, the inquiry processing unit 35 determines whether or not there is a possibility that its own node include data matching the condition of the time on the basis of the extracted condition relating to the time extracted in Step S41. In a case in which there is a possibility that its own node includes the data (Yes in Step S42), the process proceeds to the next Step S43. On the other hand, in a case in which there is no possibility that its own node includes the data (No in Step S42), the process proceeds to Step S44.

Next, in a case in which the process proceeds to Step S43, the inquiry processing unit 35 searches the database of its own node and acquires a search result in Step S43.

Next, in Step S44, the inquiry processing unit 35 determines, on the basis of the extracted condition relating to the time extracted in Step S41, whether or not there is a possibility that a child node and subsequent nodes include data matching the condition. In a case in which there is a possibility that there is a possibility that the child node and subsequent nodes include the data (Yes in Step S44), the process proceeds to the next Step S45. On the other hand, in a case in which there is no possibility that the child node and subsequent nodes include the data (No in Step S44), the whole process of this flowchart ends.

Next, in a case in which the process proceeds to Step S45, the inquiry processing unit 35 transmits a search request to the child node and acquires a search result from the child node in Step S45. When its own node is connected to a plurality of child nodes, in a case in which the storage range of data is different for each branch of the child nodes, a search request may be transmitted to only a child node of a branch having a possibility that data matching the search condition is included. When the process of this step ends, the whole process of this flowchart ends.

Details of the determination methods used in Steps S42 and S44 are as follows. In Step S42 described above, the inquiry processing unit 35 refers to the information of its own node storage range of the storage information storing unit 22. In this way, the inquiry processing unit 35 determines whether or not the condition of the time included in the search request and the range represented by the upper limit and the lower limit of its own node storage range overlap each other.

In Step S44 described above, the inquiry processing unit 35 performs a determination as below.

In a case in which the storage information storing unit 22 stores the storage information of the type illustrated in FIG. 5A, the inquiry processing unit 35 determines whether or not the condition of the time included in the search request and a range larger (newer) than the upper limit of its own node storage range overlap each other. On the other hand, in a case in which the storage information storing unit 22 stores the storage information of the type illustrated in FIG. 5B, the inquiry processing unit 35 determines whether or not the condition of the time included in the search request and a range larger (newer) than the lower limit of a child node storage range overlap each other for each child node.

Hereinafter, a retrieval performance of a case in which this embodiment is used and a retrieval performance of a case in which a conventional technology is used will be compared with each other on the basis of examples. The database system according to this embodiment is configured by node devices of four hierarchy levels. A first layer (root layer) includes one node device. The node device of this root layer is connected to 100 node devices of a second layer. Each of the node devices of the second layer is connected to 100 node devices of a third layer. In other words, there are 10,000 node devices of the third layer. Each of the node devices of the third layer is connected to 100 node devices of a fourth layer. In other words, there are 1,000,000 (one million) node devices of the fourth layer. The fourth layer is a leaf layer, and each node device of the fourth layer generates data on the basis of a signal from a sensor or the like. The capacity of the database of each node device of the fourth layer is 1 Gigabytes (GB). In other words, the database capacity of all of the one million node devices of the fourth layer is one petabytes (PB). The database capacity of each of the 10,000 node devices of the third layer is 100 GB. In other words, the database capacity of all the 10,000 node devices of the third layer is one petabytes (PB). The database capacity of each of 100 node devices of the second layer is 10 terabytes (TB). In other words, the database capacity of all the 100 node device of the second layer is one petabytes (PB). The database capacity of one node device of the first layer (the root layer) is 1 PB. In other words, total capacity of the database of all the node devices of the first layer to the fourth layer is 4 PB.

On the other hand, by employing a configuration using a conventional technology, 1,000,000 (one million) data managing apparatuses store data. Such one million data managing apparatuses are connected to a network in a flat manner without configuring a tree structure or a layered structure. The database capacity of each of the data managing apparatuses is 4 GB. In other words, the database capacity of all of the one million data managing apparatuses is 4 PG. In other words, the total database capacity is equal to that of a case in which this embodiment described above is used.

On the premise of the description presented above, the performances of the conventional technology and this embodiment will be compared with each other. As the performance of the hardware, it is assumed that the data transmission speed of the network is 1 GB/sec, and the access speed of the database (configured using a magnetic hard disk device) is 100 MB/sec.

In the example of this embodiment, retrieval is performed by the node devices of each layer (from the first layer to the fourth layer). In the node device of the first layer (root layer), for a sequential access at the database of a capacity of 1 PB at an access speed of 100 MB/sec, 1 [PB]/100 [MB/sec]=10,000,000 seconds (10 million seconds) is necessary. An access to the database of each of node devices of the second layer to the fourth layer and the transmission of acquired data to a layer of a layer of a higher rank are sufficiently fast in accordance with the speed assumed above and thus, are concealed by ten million seconds of the data access time of the first layer (root layer).

On the other hand, in the example of the conventional technology, for an access to the data of 4 PB at a speed of 100 MB/sec, a total of 4 [PB]/100 [MB/sec]=40,000,000 seconds (40 million seconds) is necessary.

In other words, the performance of a case in which retrieval is performed in the example of this embodiment is above the performance of the case of the example of the conventional technology.

Next, for a case in which a time condition is included inside a search request, by using the premise described above, the performances of the conventional technology and this embodiment are compared with each other. Also here, as the hardware performances, it is assumed that the data transmission speed of the network is 1 GB/sec, and the access speed of the database (configured by a magnetic hard disk device) is 100 MB/sec.

The data storage status in each layer of this embodiment is as below. In other words, the fourth layer (leaf layer) stores data of the current time point to 24 hours ago (this will be referred to as the “current day”). The third layer stores data of 24 hours ago to 48 hours ago (this will be referred to as “one day ago”). The second layer stores data of 48 hours ago to 72 hours ago (this will be referred to as “two days ago”). The first layer stores data of 72 hours ago to 96 hours ago (this will be referred to as “three days ago”). Here, a case will be assumed in which a condition for a search of only data of one day ago (in other words, the data stored in the node device of the third layer) is included inside a search request as the condition of time. In other words, data of 100 GB is searched in each of 10,000 node devices of the third layer. In other words, 10,000 parallel data accesses are performed. A time that is necessary for these data accesses is 100 [GB]/100 [MB/sec]=1,000 sec (time A). The process of transmission of data acquired as results of the accesses from the third layer to the second layer is performed in parallel in 100 devices (the number of node devices of the second layer is 100). A time that is necessary for the transmission of data from the third layer to the second layer is 10 [TB]/1 [GB/sec]=10,000 sec (time B). The process of transmitting this data from the second layer to the first layer is performed in parallel (sequentially) in one device (the number of the node devices of the first layer is one). A time that is necessary for the transmission of data from the second layer to the first layer is 1 [PB]/1[GB/sec]=1,000,000 sec (time C). When the time A, the time B, and the time C are added up, a total time that is necessary for the retrieval process is 1,011,000 sec.

On the other hand, in the example of the conventional technology, data of 1 PB is sequentially accessed. In other words, a time that is necessary for this data access is 1 [PB]/100 [MB/sec]=a total of 10,000,000 sec (10 million sec).

Also in this case, the performance of a case in which retrieval is performed in the example of this embodiment is above the performance of the case of the example of the conventional technology.

### Second Embodiment

Next, a second embodiment will be described. Hereinafter, description of items common to the embodiment described above will not be presented, and items that are distinctive in this embodiment will be focused in the description.

The configuration of data stored in the database system according to the first embodiment is as illustrated in FIG. 3. On the other hand, a database system 101 according to this embodiment stores a plurality of series (time series) of data.

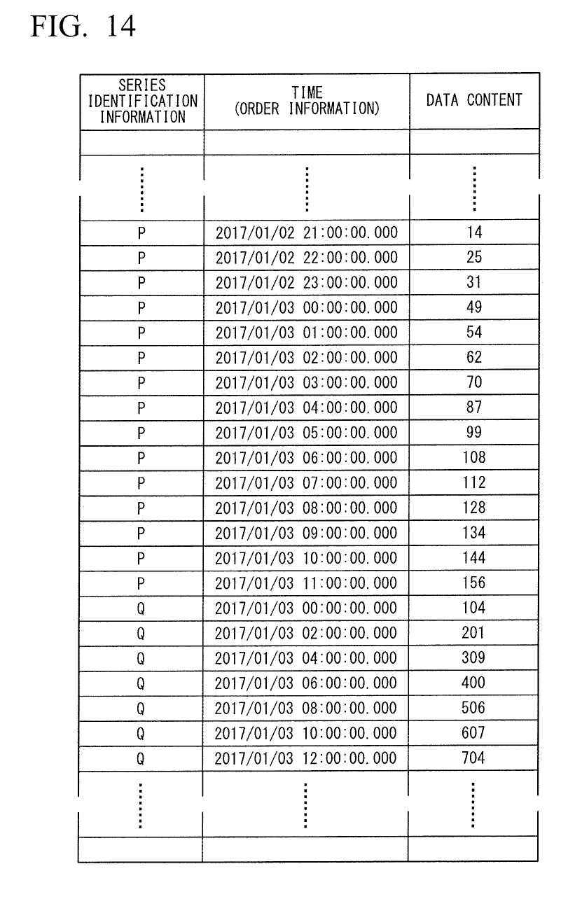

FIG. 14 is a schematic diagram illustrating the basic structure of data stored by the database system 101 according to this embodiment. A data storing unit 20 of each node device 10 included in the database system 101 stores data having the structure illustrated in the drawing. As illustrated in the drawing, the database system 101 stores and manages time (order information) and a data content in association with each other. As a feature of this embodiment, the database system 101 manages data of a plurality of series in a node device group of one tree structure. For this reason, a table that is illustrates include series identification information as one of data items. The series identification information is used for identifying each series of data. In the example illustrated in the drawing, two values “P” and “Q” are included in the table as the series identification information.

For example, the series identification information “P” and “Q” correspond to two types of sensors (a sensor P and a sensor Q) generating data in a leaf node device 10L.

In other words, the data storing unit 20 according to this embodiment stores a plurality of series of data ordered using order information (time).

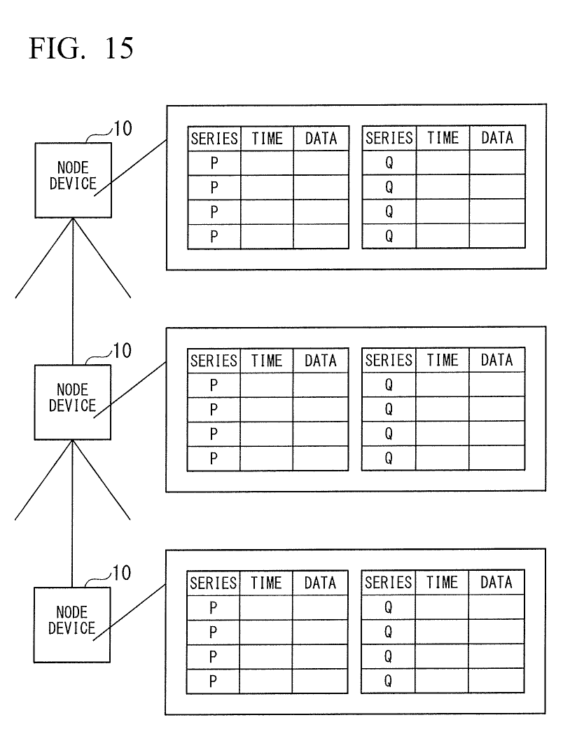

FIG. 15 is a schematic diagram illustrating a status in which data (see FIG. 14) having a plurality of series is stored in node devices having a tree structure in a distributed manner. In the drawing, three node devices 10 have a relation of parent-child-grandchild. In the drawing, illustration of node devices other than these three node devices is omitted. Among such node devices, data is stored to be distributed using information (order information) of time as a key, which is similar to the first embodiment. However, in this embodiment, two series of data denoted by series identification information “P” and “Q” are logically independently stored inside the node devices 10.

Here, while a case in which the number of series of data managed by the database system 101 is two is illustrated as an example, the number of series of data may be three or more.

In this embodiment, as a method of distributing data among nodes using time (order information) as a key, there are two types of systems. In a first system, distribution of data among nodes is performed using a storage range that is common to a plurality of series. In a second system, distribution of data among nodes is performed using storage ranges of a plurality of series that are independent from each other. Hereinafter, specific examples of these two systems will be described.

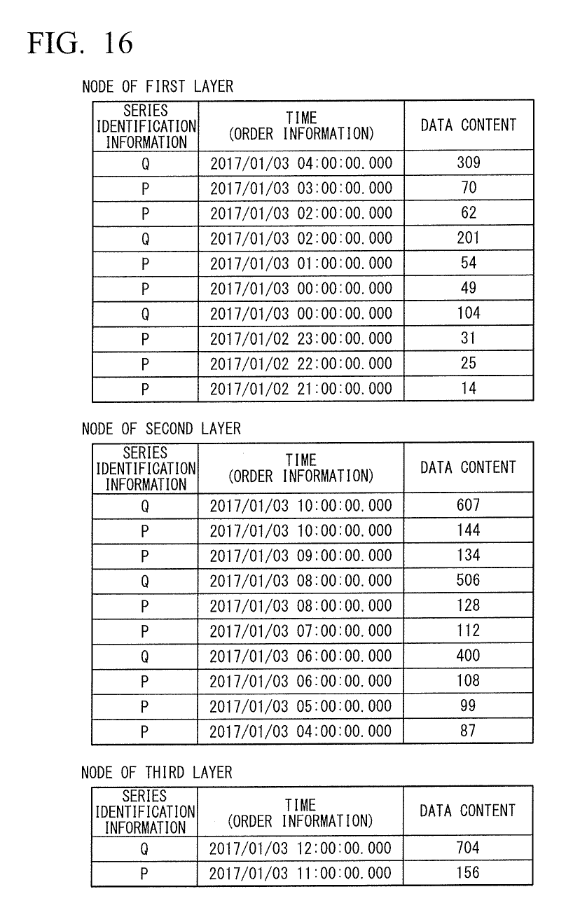

FIG. 16 is a schematic diagram illustrating an example of storage of data of a case in which a common storage range is used for a plurality of series by using the first system described above. An example of data illustrated here corresponds to the data illustrated in FIG. 15. In the drawing, a node of the first layer is a direct parent of a node of the second layer. A node of the second layer is a direct parent of a node of the third layer. In this system, a storage range common to a plurality of series is set in each node.

More specifically, in the node of the first layer, regardless of the series P or Q, the upper limit of its own node storage range is “2017/01/03 04:00:00.000”, and the lower limit is “2017/01/02 21:00:00.000”. In the node of the second layer, similarly, regardless of the series P or Q, the upper limit of its own node storage range is “2017/01/03 10:00:00.000”, and the lower limit is “2017/01/03 04:00:00.000”. In the node of the third layer, similarly, regardless of the series P or Q, the upper limit of its own node storage range is “2017/01/03 04:00:00.000”, and the lower limit is “2017/01/02 21:00:00.000”.

In other words, in this case, the storage processing unit 32 saves data to be saved from the data storing unit 20 into the parent node device or deletes data to be deleted from the data storing unit 20 at a root node in the order represented by the order information that is common to the plurality of series data.

In this way, its own node storage range does not depend a data series. Thus, in this system, the storage information storing unit 22 of each node device 10 stores the information (its own node storage range or the like) of the common storage range without being dependent on a data series.

According to this system (first system) of this embodiment, data can be saved into the parent node in the order of oldest to newest data on the basis of the amount of a sum data amount over the data series.

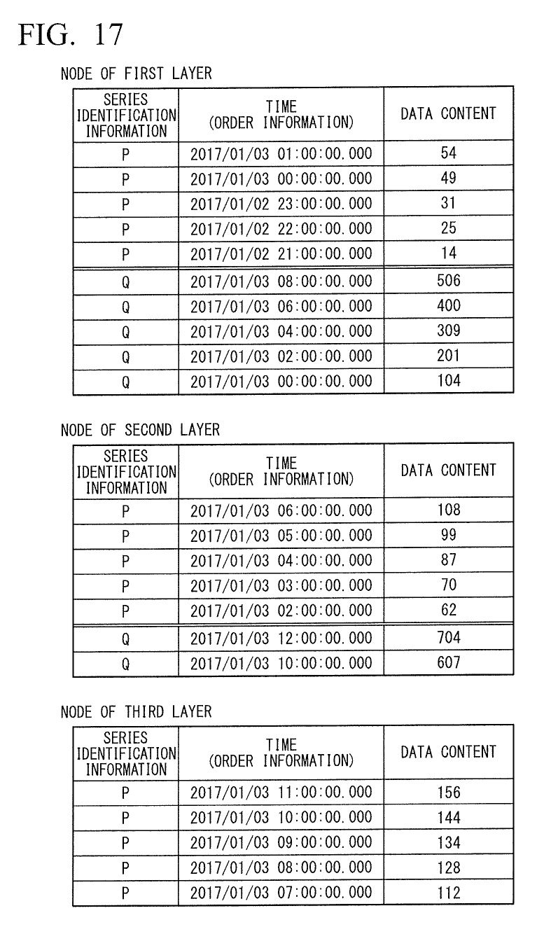

FIG. 17 is a schematic diagram illustrating an example of data storage of a case in which data distribution among nodes is performed using an independent storage range for each of a plurality of series by using the second system. An example of data illustrated here corresponds to the data illustrated in FIG. 15. In the drawing, a node of the first layer is a direct parent of a node of the second layer. A node of the second layer is a direct parent of a node of the third layer. In this system, a storage range is set for each series.

More specifically, for the series P of the node of the first layer, the upper limit of its own node storage range is “2017/01/03 01:00:00.000”, and the lower limit is “2017/01/02 21:00:00.000”. For the series Q of the node of the first layer, the upper limit of its own node storage range is “2017/01/03 08:00:00.000”, and the lower limit is “2017/01/03 00:00:00.000”.

For the series P of the node of the second layer, the upper limit of its own node storage range is “2017/01/03 06:00:00.000”, and the lower limit is “2017/01/03 02:00:00.000”. For the series Q of the node of the second layer, the upper limit of its own node storage range is “2017/01/03 12:00:00.000”, and the lower limit is “2017/01/03 10:00:00.000”.

For the series P of the node of the third layer, the upper limit of its own node storage range is “2017/01/03 11:00:00.000”, and the lower limit is “2017/01/03 07:00:00.000”. In the node of the second layer, data of the series Q is not present.

In other words, in this case, the storage processing unit 32 saves data to be saved from the data storing unit 20 into the parent node device or deletes data to be deleted from the data storing unit 20 in the order represented by the order information of each of the plurality of series data.

In this way, its own node storage range is different for each data series. Thus, in this system, the storage information storing unit 22 of each node device 10 stores information (its own node storage range or the like) of the storage range for each data series.

According to this system (the second system) of this embodiment, data can be saved into the parent node in the order of oldest to newest data individually for each data series.

### Third Embodiment

Next, a third embodiment will be described. Hereinafter, description of items common to each embodiment described above will not be presented, and items that are distinctive in this embodiment will be focused in the description. As a feature of a database system according to this embodiment, the node device 10 does not necessarily need to be connected in a tree structure pattern.

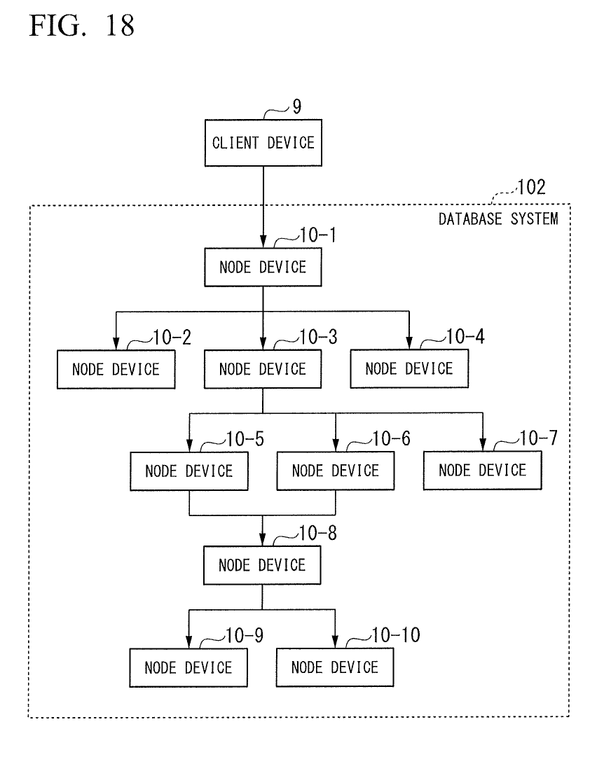

FIG. 18 is a schematic diagram illustrating an example of the configuration of the database system 102 according to this embodiment. As illustrated in the drawing, also in this embodiment, the database system 102 is configured by connecting a plurality of node devices 10. Between the node devices, a relation of a parent node and a child node is defined. In the drawing, the source side of a directional arrow is a parent node, and the destination side is a child node. In the database system 102, for example, a node device 10-8 includes two parents of node devices 10-5 and 10-6. In this way, in the database system 102, the node devices 10 may not be connected in a tree structure. In a node device group configuring the database system 102, a partial order relating to the relation of a parent and a child is satisfied. In other words, a certain node device is one of a lineal ancestor, a lineal descendant, or neither an ancestor nor a descendant of another node device. There is no relation that a certain node device is an ancestor and a descendant of another node device. In other words, a close path is not present in a directed graph representing the relation of a parent and a child.

In this embodiment, similar to each embodiment described above, data is stored and saved using time associated with the data as a key. Similar to each embodiment described above, data is saved from the child node side to the parent node side. As a saving rule of data, for example, any one of the four types of rules described in the first embodiment may be used. In a case in which a certain node device 10 has a plurality of parents, the node device 10 saves data by appropriately distributing parent node devices that are saving destinations. Although a method of distributing the parent node devices that are saving destinations is arbitrary, for example, a parent node device that is the moving destination of data is determined by delimiting time (order information) associated with the data. Alternatively, for example, a parent node device that is a moving destination is determined on the basis of a remainder when time (order information) associated with the data is divided by the number of parent node devices connected to the node device. Alternatively, for example, a parent node device that is a moving destination is determined on the basis of a result acquired by applying a hash function to the data.

In this embodiment, similar to each embodiment described above, a data search process is performed.

In other words, the node device 10 appropriately distributes search requests for child node devices. However, in a case in which a plurality of parent nodes (for example, node devices 10-5 and 10-6) have one common child node (a node device 10-8), a parent node from among the plurality of parent nodes from which a search request is transmitted to the common child node is set in advance by using a rule or the like.

According to this embodiment, the form of connections between node devices may not be necessarily a tree structure pattern, and the system can be configured in a flexible manner. Also in this embodiment, by saving data from a child node into a parent node, the storage unit of each node device can be effectively used. It can be managed that data of a certain range is present in a specific node device on the basis of the order information.

### Fourth Embodiment

Next, a fourth embodiment will be described. Hereinafter, description of items common to each embodiment described above will not be presented, and items that are distinctive in this embodiment will be focused in the description. As a feature of a database system according to this embodiment, node devices 10 do not necessarily need to be connected in a tree structure pattern, and a configuration in which a single root node device is not included may be employed.

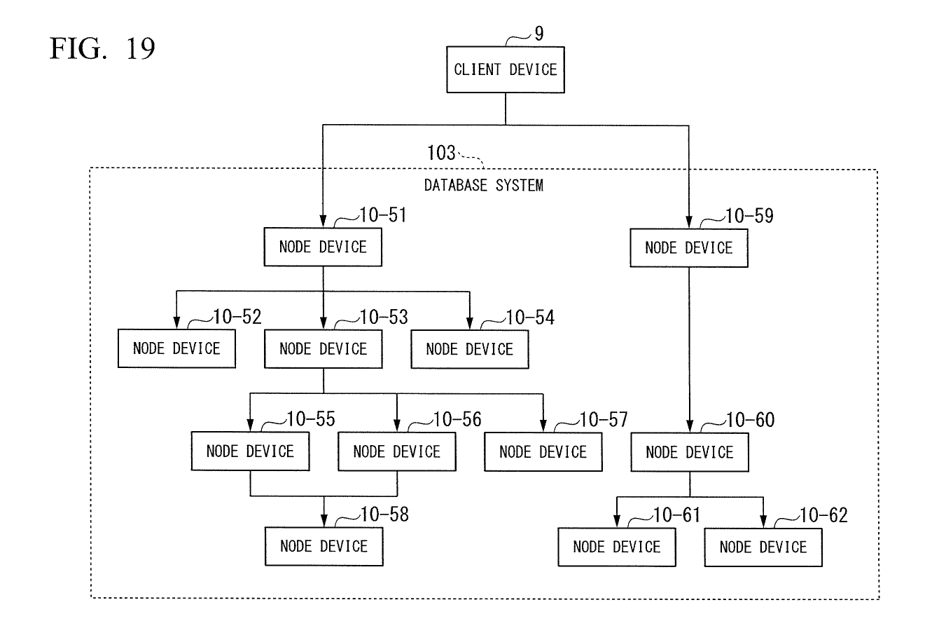

FIG. 19 is a schematic diagram illustrating an example of the configuration of the database system 103 according to this embodiment. As illustrated in the drawing, also in this embodiment, the database system 102 is configured by connecting a plurality of node devices 10. Between the node devices, a relation of a parent node and a child node is defined. In the drawing, the source side of a directional arrow is a parent node, and the destination side is a child node.

In this embodiment, similar to each embodiment described above, data is stored and saved using time associated with the data as a key. Similar to each embodiment described above, data is saved from the child node side to the parent node side. As a saving rule of data, for example, any one of the four types of rules described in the first embodiment may be used. However, in the database system 103, a group of node devices 10-51 to 10-58 and a group of node devices 10-59 to 10-62 are not connected as a graph. Thus, also in a case in which data is saved between nodes, these two groups are delimited, and data is not moved therebetween.

In this embodiment, similar to each embodiment described above, a data search process is performed.

In other words, the node device 10 appropriately distributes search requests for child node devices. However, in a case in which a plurality of parent nodes of the highest rank are present in the parent-child relation of a node (for example, node devices 10-51 and 10-59 illustrated in FIG. 19), a client device 9 distributes search requests to the plurality of node devices (the node devices 10-51 and 10-59). Alternatively, a front end processing device may be provided between the client device 9 and the node devices that are parent nodes of the highest rank, and the front end processing device may distribute search requests to the plurality of node devices that are the parent nodes of the highest rank.

According to this embodiment, all the node devices does not necessarily need to be connected as one. In other words, as a graph structure of inter-node connections, a non-connected node device group may be included. Accordingly, system can be configured in a flexible manner. Also in this embodiment, by saving data from a child node into a parent node, the storage unit of each node device can be effectively used. It can be managed that data of a certain range is present in a specific node device on the basis of the order information.

In each embodiment described above, as the information representing the order of data stored in the database system, the information of the time (date and time) associated with each piece of data is used. However, instead of the time, the order of data may be represented using other information. For example, a serial number (sequence number) representing the order of generation of data may be assigned to each piece of data, and the serial number may be used as the order information. Alternatively, any other numerical value data other than the time (Japanese standard time or Coordinated Universal Time) may be assigned to each piece of data, and the data may be used as the order information. In this way, also in a case in which order information other than the time (date and time) is used, the management of the range of data to be saved from a child node to a parent node cam be performed using the order information. Also in a case in which it is determined whether a search request is processed inside its own node or distributed to a child node, the determination may be performed based on the order information. In other words, order information that is appropriately assigned may be applied instead of the time (date and time) according to each embodiment described above.

In each embodiment described above, in managing the order of data by using the order information, a side having a larger numerical value is set as the side of new data, and a side having a smaller numerical value is set as the side of old data. However, the relation between the order of “new” and “old” and the numerical value may be reversed.

According to at least one embodiment described above, by including the storage processing unit 32 that sequentially saves data among nodes from a child to a parent in accordance with the saving rule stored by the saving rule storing unit 23, the storage units of the node devices 10 can be effectively used, and the concentration of data on the central server apparatus can be avoided. The data storage capacity of the whole database system can be increased. According to at least one embodiment described above, by including the inquiry processing unit 35 that distributes search requests from the higher rank, the search process can be performed in a multi-parallel manner, and accordingly, the efficiency of the data search is improved.

The function of the node device or the client device according to the embodiment described above may be realized by a computer. In such a case, by recording a program used for realizing the function on a computer-readable recording medium and causing the computer system to read and execute the program recorded on this recording medium, the function may be realized. The “computer system” described here includes an OS and hardware such as peripherals. The “computer-readable recording medium” represents a portable medium such as a flexible disc, a magneto-optical disk, a ROM, a CD-ROM, a DVD-ROM, or a USB memory or a storage device such as a hard disk built in the computer system. Furthermore, the “computer-readable recording medium” may include a medium dynamically storing the program for a short time such as a communication line of a case in which the program is transmitted through a network such as the Internet or a communication circuit line such as a telephone line and a medium storing the program for a predetermined time such as an internal volatile memory of the computer system that becomes a server or a client in such a case. The program described above may be a program used for realizing a part of the function described above or a program that can realize the function described above in combination with a program that is already recorded in the computer system.

While preferred embodiments of the invention have been described and illustrated above, it should be understood that these are exemplary of the invention and are not to be considered as limiting. These embodiments may be performed in various other forms, and additions, omissions, substitutions, and other modifications can be made without departing from the spirit or scope of the present invention. These embodiments and modifications thereof are included in the scope or spirit of the present invention and, similarly, are included in the scope of the invention defined in the claims and the scope of equivalency thereof. Accordingly, the invention is not to be considered as being limited by the foregoing description, and is only limited by the scope of the appended claims.

### EXPLANATION OF REFERENCES

10, 10-1 to 10-10, and 10-51 to 10-62 Node device

10R Node device (root node device)

10L Node device (leaf node device)

11 Parent node device

12 Child node device

20 Data storing unit

21 Connection list storing unit

22 Storage information storing unit

23 Saving rule storing unit

31 Data collecting unit

32 Storage processing unit

35 Inquiry processing unit

100, 101, 102, and 103 Database system

What is claimed is:

1. A database system formed by connecting a plurality of node devices in parent-child relations,
each of the node devices including:
a data storing unit storing data;
a saving rule storing unit storing a saving rule used for saving the data stored in the data storing unit to a parent node device in a case in which its own node device is not a parent of a highest rank and deleting the data stored in the data storing unit in a case in which its own node device is the parent of the highest rank;
a storage processing unit receiving a registration request for data, writing the registration request in the data storing unit, and saving data to be saved from the data storing unit in a parent node device in an order represented by order information associated with the data or deleting data to be deleted from the data storing unit by referring to the saving rule of the saving rule storing unit; and
an inquiry processing unit receiving a search request for data, searching the data stored in the data storing unit of its own node device to acquire a first search result, transmitting the search request to a child node device to acquire a second search result from the child node device, and transmitting the first search result and the second search result to a request source.

2. The database system according to claim 1,
wherein the saving rule storing unit stores the saving rule used for saving a predetermined amount of the data stored in the data storing unit in a parent node device at a predetermined time interval in a case in which its own node device is not a parent of a highest rank and deleting a predetermined amount of the data at a predetermined time interval in a case in which its own node device is the parent of the highest rank.

3. The database system according to claim 1,
wherein the saving rule storing unit stores the saving rule used for calculating an amount of the data written when the data is written in the data storing unit of its own node device, and in a case in which free space of the data storing unit is insufficient, saving data that is necessary for securing the free space among the data stored in the data storing unit in a parent node device in a case in which its own node device is not a parent of a highest rank and deleting data that is necessary for securing the free space among the data in a case in which its own node device is the parent of the highest rank.

4. The database system according to claim 1,
wherein the saving rule storing unit stores the saving rule used for, when a capacity insufficiency error occurs as a result of attempting to write the data in the data storing unit of its own node device, saving the data stored in the data storing unit in a parent node device in a case in which its own node device is not a parent of a highest rank and deleting the data in a case in which its own node device is the parent of the highest rank.

5. The database system according to claim 1,
wherein the saving rule storing unit stores the saving rule used for, when free space of the data storing unit of its own node device is monitored, and the free space is below a predetermined threshold, saving the data stored in the data storing unit in a parent node device in a case in which its own node device is not a parent of a highest rank and deleting the data in a case in which its own node device is the parent of the highest rank.

6. The database system according to claim 1,
wherein the data storing unit stores a plurality of series of the data ordered using the order information, and
wherein the storage processing unit saves data to be saved from the data storing unit into a parent node device or deletes data to be deleted from the data storing unit in an order represented by the order information that is common to the plurality of series of the data.

7. The database system according to claim 1,
wherein the data storing unit stores a plurality of series of the data ordered using the order information, and
wherein the storage processing unit saves data to be saved from the data storing unit in a parent node device or deletes data to be deleted from the data storing unit in an order represented by the order information of each of the plurality of series of the data.

8. The database system according to claim 1, further comprising:
a storage information storing unit storing information of a range of the order information associated with data stored in the data storing unit of its own node device,
wherein the inquiry processing unit extracts a search condition relating to the order information included in the received search request, and in a case in which data matching the search condition is not stored in the data storing unit of its own node device, does not perform a search of the data stored in the data storing unit of its own node device and acquires data of an empty set as the first search result.

9. The database system according to claim 1, further comprising:
a descendant node storage information storing unit storing information of a range of the order information associated with data stored in the data storing unit of a node device of a child or a lower rank,
wherein the inquiry processing unit extracts a search condition relating to the order information included in the received search request, and in a case in which data matching the search condition is not stored in the data storing unit of the node device of the child or the lower rank, does not transmit the search request to the node device of the child and acquires data of an empty set as the second search result for the node device of the child.

10. The database system according to claim 1, wherein the order information is information of time.

11. A data processing method using a database system formed by connecting a plurality of node devices in parent-child relations,
wherein, in each of the node devices,
a data storing unit stores data,
a saving rule storing unit stores a saving rule used for saving the data stored in the data storing unit in a parent node device in a case in which its own node device is not a parent of a highest rank and deletes the data stored in the data storing unit in a case in which its own node device is the parent of the highest rank,
a storage processing unit receives a registration request for data, writes the registration request in the data storing unit, and saves data to be saved from the data storing unit in a parent node device in an order represented by order information associated with the data or deletes data to be deleted from the data storing unit by referring to the saving rule of the saving rule storing unit, and
an inquiry processing unit receives a search request for data, searches the data stored in the data storing unit of its own node device to acquire a first search result, transmits the search request to a child node device to acquire a second search result from the child node device, and transmits the first search result and the second search result to a request source.
